(19) United States
(12) Patent Application Publication
(10) Pub. No.: US 2014/0006934 A1
(43) Pub. Date: Jan. 2, 2014

(54) METHOD FOR REARRANGING WEB PAGE

(71) Applicants: Xuanran Wang, Beijing (CN); Dian Fan, Beijing (CN); Heng Qu, Beijing (CN); Feng Hong, Beijing (CN); Jiangji Huang, Beijing (CN)

(72) Inventors: Xuanran Wang, Beijing (CN); Dian Fan, Beijing (CN); Heng Qu, Beijing (CN); Feng Hong, Beijing (CN); Jiangji Huang, Beijing (CN)

(73) Assignee: XIAOMI INC., Haidian District, Beijing (CN)

(21) Appl. No.: 14/004,410

(22) PCT Filed: Mar. 13, 2012
(86) PCT No.: PCT/CN12/72285

§ 371 Date: Sep. 10, 2013

(30) Foreign Application Priority Data
Mar. 14, 2011 (CN) 201110060342.9

(51) Int. Cl. G06F 17/22

(52) U.S. Cl. CPC G06F 17/2247
USPC 715/235; 715/234

(57) ABSTRACT

Disclosed is a method for rearranging web pages. A mobile phone browser receives a web address and determines if a web page corresponding to the web address matches selection rules. If no, the mobile phone browser loads the web page and displays the content. If yes, the mobile phone browser retrieves HTML source code of the web page. Based on a content extraction rule, the mobile phone browser extracts elements containing actual content from the HTML source code of the web page, and extracts actual content from these elements. Next, the mobile phone browser inserts the actual content into a predefined web page template to generate a new web page. The mobile phone browser loads the new web page and displays the content of the new web page. The method adapts to screen resolutions of mobile devices, preserves information and interaction of original web pages to the greatest extent, improves the speed for loading web page, and saves network bandwidth.

### FIELD OF ART

The present disclosure relates to the field of mobile internet, and more particularly to a method for rearranging web pages.

### BACKGROUND

In the field of mobile internet, there is extensive research on how to present rich content of the Internet on mobile devices in a user-friendly manner. One crucial topic is how to display traditional Internet web pages designed for high-resolution monitors on the relatively low-resolution screens of mobile devices without compromising browsing of and interaction with the original web pages.

Some efforts have been made in this direction by current mainstream mobile browsers on the market. For example, in the early IE mobile browser for Windows Mobile OS from Microsoft, all elements in a web page are arranged in a vertical order for users' convenience. In the browser in Google's Android OS, word wrap technology is adopted. That is, during web page scaling, paragraphs of text in a web page are rearranged to wrap words according to the relationship between the current scaling ratio and the width of the screen. Therefore, screen rolling operation is not required when users are reading. In browsers from Apple iPhone and Microsoft Windows Phone 7 system, text scaling is adopted to adjust font sizes for different containers of a web page during first rendering of the web page. This ensures that when a container is scaled to the middle of the screen, the font size in the container is suitable for user reading without the need of scrolling screen left and right, successfully avoiding to repeatedly rearrange the web page layout during each scaling operation.

However, the main disadvantage of these technologies is that they only improve the reading experience for paragraphs of text on the mobile devices, but not for other web elements, such as pictures and videos. Moreover, such technologies cause partial change to the layout of web pages, which may possibly lead to disordered global layout, content repetition or large blanks, etc.

Another research direction is server rearranging technology, represented by server cache acceleration technology developed by UCWEB, which rearranges web pages by adapting fonts and width of web pages to lower screen resolutions of mobile devices, thus the connecting frequency to website servers can be reduced by caching the rearranged web pages.

However, due to the variety of mobile devices with different resolutions, the web page rearrangement by cache servers are not optimized for particular users' mobile device screens.

Some websites involves users' privacy information (e.g. e-commerce websites and on-line forums). The server rearranging technology requires a client to establish a direct connection with a cache server, so the privacy information of the users will be stored in the cache server, increasing the risk of privacy information leakage.

Due to the diversity of websites, the rearrangement results may not guarantee ease-of-use and aesthetics.

The server rearranging technology requires an enormous amount of server resource. The cost is higher.

Since rearranged web pages are cached, web pages with high real-time requirement (e.g., live web casting) may be delayed in processing, leading to the loss of real-time updating.

### SUMMARY

The purpose of the present disclosure is to provide a method for rearranging the web page, which is well suited for the screen resolution of the equipments for extremely good browsing experience. It can also preserve the information and interaction of original web pages to the greatest extent. Meanwhile non-essential elements in the web pages could be filtered out to increase the uploading speed and save the network bandwidth.

To this end, the present disclosure adopts the following technical scheme:

A method for rearranging web pages, including:
A. Mobile phone browser receives a web address.
B. Mobile phone browser determines if a web page corresponding to the web address matches selection rules. If yes, go to step C. Otherwise, load the web page and display content of the web page.
C. Mobile phone browser retrieves HTML source code of the web page.
D. Based on a content extraction rule, the mobile phone browser extracts elements containing actual content from the HTML source code of the web page, and extracts actual content from these elements.
E. Mobile phone browser inserts actual content of the web page into a predefined web page template to generate a new web page.
F. Mobile phone browser loads the new web page and displays content of the new web page.

The selection rules include web address rule, special element rule and web format rule. The web address rule is defined by regular expression. The special element rule determines whether to select the web page by searching for specific elements in the web page. The web format rule determines whether to select the web page based on an overall hierarchical structure of the web page elements.

The special element rule determines if an identifier (ID) of a body element in the web page matches a specific ID. The web format rule determines if the body of the web page includes two div elements.

The content extraction rule is implemented in XPath language.

The content extraction rule includes content extraction rules for news websites, serial story websites and online forum websites.

The actual content includes internal HTML source code and hyperlinks.

Step E also includes the following steps:
The mobile phone browser inserts actual content of the web pages into the predefined web page template.
The web page template includes a layout format for generating the new web pages based on predefined cascading style sheets (CSS) and on characteristics of the mobile phone browser.

The characteristics of the mobile phone browser include a resolution and display properties.

With the adoption of the technical scheme in the present disclosure, the following technical advantages can be achieved:
1. Since only web pages from those websites complying with specific selection rules are rearranged, the rearranged web pages provide better browsing and interaction experience.
2. Unrelated content (e.g., ads) in the original web pages can be filtered out through rearranging the web page layout, thus improving the browsing experience and saving network bandwidth.
3. In contrast to privacy concerns regarding caching and rearranging web page layout by cache servers, a complete client-side web page rearrangement is introduced such that all data interaction occurs only between the client and website server without any intervention from third party servers, thus to protect user privacy.
4. Rearranging layout of web pages downloaded from website servers in real-time ensures that the content of the web pages presented in user devices are real-time content from the website.

### BRIEF DESCRIPTION OF THE FIGURES

FIG. 1 is a flowchart illustrating a method of rearranging web pages according to an exemplary embodiment.

### DETAILED DESCRIPTION OF EMBODIMENTS

Embodiments of the present disclosure are further described in detail with reference to the accompanying figure.

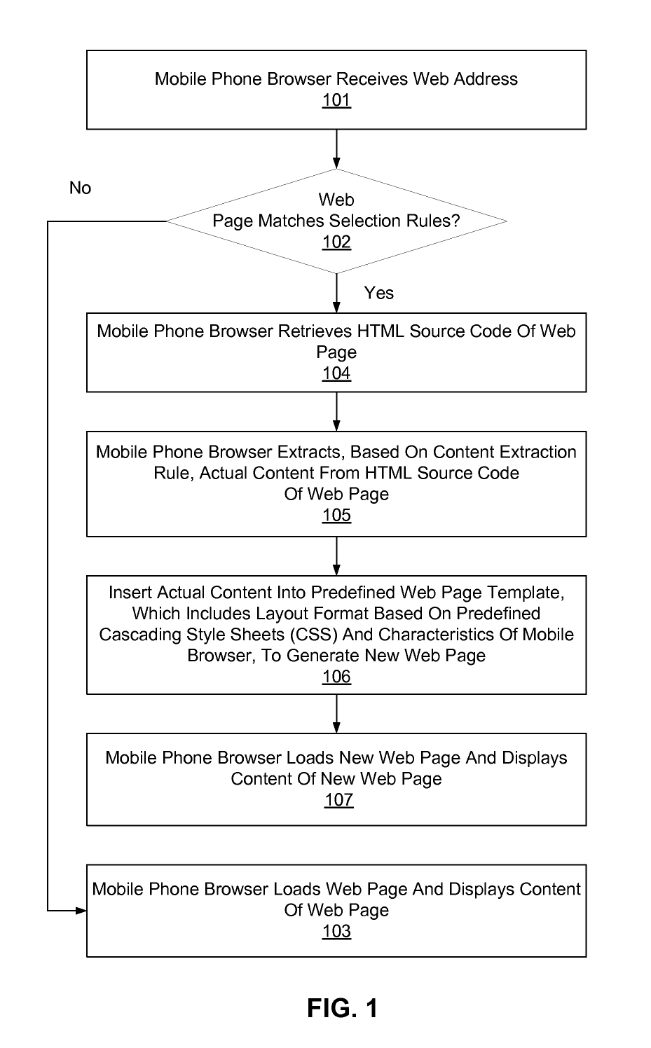

FIG. 1 is a flowchart illustrating a method of rearranging web pages according to an exemplary embodiment. As shown in FIG. 1, the process of rearranging web page layout comprises the following steps:

Step 101. Mobile phone browser receives a web address to access.

Step 102. Mobile phone browser determines if a web page corresponding to the web address matches selection rules. If yes, go to Step 104. Otherwise, go to Step 103.

The selection rules are stored in the mobile phone browser client, including a web address rule, a special element rule and a web format rule.

The web address rule is defined by regular expression.

The special element rule determines whether to select the web page by searching for specific elements in the web page. For example, a special element rule determines if an identifier (ID) of a body element in the web page matches a specific ID.

The web format rule determines whether to select the web page based on an overall hierarchical structure of the web page elements in the web page. For example, a web format rule determines if a body of the web page includes two div elements.

Step 103. Mobile phone browser loads the web page and displays content of the web page.

Step 104. Mobile phone browser retrieves HTML source code of the web page.

Step 105. Based on a content extraction rule, the mobile phone browser extracts elements containing actual content from the HTML source code of the web page, and extracts actual content from these elements. The actual content includes internal HTML source code and hyperlinks.

The content extraction rule is stored in the mobile phone browser client, including content extraction rules for news websites, serial story websites and online forum websites. Different content extraction rules are defined for different types of web pages. Since content extraction rules target individual HTML elements or a group of HTML elements, they are often implemented in XPath language.

Step 106. Mobile phone browser inserts actual content of the web page into a predefined web page template to generate a new web page. The web page template includes a layout format for generating the new web pages based on predefined cascading style sheets (CSS) and characteristics of the mobile phone browser. The characteristics of the mobile phone browser include a resolution and display properties.

Step 107. Mobile phone browser loads the new web page and displays content of the new web page. The web page template and its included layout format for generating the new web page differ for different types of web pages, whereas for the same type of web pages, the same web page template and layout style are applied to ensure consistency in the layout of the rearranged web pages.

The above is a detailed description of the technical features of the present disclosure based on a preferred embodiment. However, it should be appreciated that the present disclosure is capable of a variety of embodiments and various modifications by those skilled in the art, and all such variations or changes shall be embraced within the scope of the following claims.

1. A method of rearranging a web page for mobile phone browsing, the method comprising the following steps:
a mobile phone browser receives a web address;
the mobile phone browser determines whether a web page corresponding to the web address matches selection rules; and
if the mobile phone browser determines the web page matches the selection rules:
the mobile phone browser retrieves HTML source code of the web page;
the mobile phone browser, based on a content extraction rule, extracts elements containing actual content from the HTML source code of the web page, and extracts actual content from the elements;
the mobile phone browser inserts actual content of the web page into a predefined web page template to generate a new web page; and
the mobile phone browser loads the new web page and displays content of the new web page.

2-8. (canceled)

9. A method for web page rearrangement for mobile phone browsing, the method comprising a mobile phone browser performing the steps of:
determining whether a web page matches selection rules;
if the web page does not match selection rules, then displaying the content of the web page on the mobile phone browser;
if the web page does match selection rules:
retrieving source code of the web page;
extracting actual content from the source code of the web page;
inserting the extracted actual content into a predefined web page template to generate a new web page; and
displaying the new web page on the mobile phone browser.

10. The method of claim 9, wherein the selection rules include a web address rule.

11. The method of claim 10, wherein the web address rule determines whether a web address of the web page is matched by a regular expression.

12. The method of claim 9, wherein the selection rules include a special element rule.

13. The method of claim 12, wherein the special element rule determines whether an identifier (ID) of a body element in the web page matches a specific ID.

14. The method of claim 9, wherein the selection rules include a web format rule.

15. The method of claim 14, wherein the web format rule determines if a body of the web page includes two div elements.

16. The method of claim 9, wherein extracting actual content comprises:
extracting individual HTML elements from the HTML source code of the web page; and
extracting actual content from the HTML elements.

17. The method of claim 16, wherein extracting actual content from the HTML source code of the web page is based on content extraction rules implemented in XPath language.

18. The method of claim 16, wherein extracting actual content from the HTML source code of the web page is based on content extraction rules that depend on the type of website containing the web page.

19. The method of claim 18, wherein the content extraction rules include content extraction rules for news websites, for serial story websites and for online forums.

20. The method of claim 16, wherein extracting actual content from the HTML source code of the web page is based on content extraction rules that filter out ads.

21. The method of claim 16, wherein extracting actual content from the HTML source code of the web page is based on content extraction rules that are stored in the mobile browser.

22. The method of claim 9, wherein the predefined web page template includes a layout format for generating the new web page based on predefined cascading style sheets (CSS) and characteristics of the mobile phone browser.

23. A non-transitory computer-readable storage medium storing executable computer program instructions for web page rearrangement for mobile phone browsing, the computer program instructions comprising instructions for:
determining whether a web page matches selection rules;
if the web page does not match selection rules, then displaying the content of the web page on the mobile phone browser;
if the web page does match selection rules:
retrieving source code of the web page;
extracting actual content from the source code of the web page;
inserting the extracted actual content into a predefined web page template to generate a new web page; and
displaying the new web page on the mobile phone browser.

24. The non-transitory computer-readable storage medium of claim 23, wherein the selection rules include a web address rule, a special element rule and a web format rule.

25. The non-transitory computer-readable storage medium of claim 23, wherein extracting actual content comprises:
extracting individual HTML elements from the HTML source code of the web page; and
extracting actual content from the HTML elements.

26. The non-transitory computer-readable storage medium of claim 25, wherein extracting actual content from the HTML source code of the web page is based on content extraction rules that depend on the type of website containing the web page.

27. The non-transitory computer-readable storage medium of claim 25, wherein extracting actual content from the HTML source code of the web page is based on content extraction rules that filter out ads.
